(19) United States
(12) Patent Application Publication
(10) Pub. No.: US 2025/0173970 A1
(43) Pub. Date: May 29, 2025

(54) METHOD

(71) Applicant: TOYOTA JIDOSHA KABUSHIKI KAISHA, Toyota-shi (JP)

(72) Inventors: Takeshi TAKEMOTO, Nagoya-shi (JP); Yosuke KAMADA, Yokohama-shi (JP); Satoshi KUME, Nagakute-shi (JP); Satoru SAKUMA, Nagakute-shi (JP); Yuho KATO, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 18/813,464

(22) Filed: Aug. 23, 2024

(30) Foreign Application Priority Data
Nov. 28, 2023 (JP) 2023-200972

(51) Int. Cl. G06T 19/00; G06Q 30/0601; G06T 15/50

(52) U.S. Cl. CPC G06T 19/00; G06Q 30/0643; G06T 15/50; G06T 2200/24

(57) ABSTRACT

The method executed by the terminal device includes: receiving, via an input unit, an input by a user of a vehicle on which the user is considering purchase and an environmental condition on which the vehicle is placed; transmitting, via the communication unit, first information indicating the vehicle and the environmental condition; transmitting, via the communication unit, second information indicating an object placed in a vehicle cabin by the user; acquiring, via the communication unit, an image representing an object placed in the vehicle under the environmental condition, generated based on the first information and the second information; and outputting, via the output unit, the image.

### CROSS-REFERENCE TO RELATED APPLICATION

This application claims priority to Japanese Patent Application No. 2023-200972 filed on Nov. 28, 2023, incorporated herein by reference in its entirety.

### BACKGROUND

### 1. Technical Field

The present disclosure relates to a method.

### 2. Description of Related Art

Conventionally, there is a technique of providing a simulation of a vehicle cabin of a vehicle to a user considering to purchase the vehicle. For example, Japanese Unexamined Patent Application Publication No. 2017-182560 (JP 2017-182560 A) discloses a vehicle interior simulation device capable of obtaining a final interior image by sequentially combining selected images of the interior of a vehicle and gradually confirming the three-dimensional image of the entire interior while displaying the same.

### SUMMARY

Although a user may wish to see the situation in which his/her private object is placed in the vehicle to be purchased, it is difficult to confirm the situation with a real vehicle. Thus, there is room for improvement with the technique of providing a simulation of a vehicle cabin of a vehicle to a user considering to purchase the vehicle.

An aspect of the present disclosure provides a method executed by a terminal device including an input unit, an output unit, a communication unit, and a control unit, in which
the control unit performs a process including
receiving, via the input unit, an input by a user of a vehicle that the user is considering to purchase and an environment condition for an environment in which the vehicle is to be placed,
transmitting, via the communication unit, first information indicating the vehicle and the environment condition,
transmitting, via the communication unit, second information indicating an object to be placed in a vehicle cabin of the vehicle by the user,
acquiring, via the communication unit, an image generated based on the first information and the second information and representing the object placed in the vehicle in the environment condition, and outputting the image via the output unit.

According to the present disclosure, it is possible to improve a technique of providing a simulation of a vehicle cabin of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to a first embodiment;

FIG. 2 is a flowchart illustrating an operation of the system according to the first embodiment;

FIG. 3 is a diagram for explaining an image output to the terminal device according to the first embodiment;

FIG. 4A is a diagram illustrating an operation of the system according to a second embodiment; and

FIG. 4B is a diagram illustrating the operation of the system according to the second embodiment.

### DETAILED DESCRIPTION OF EMBODIMENTS

### First Embodiment

Hereinafter, a first embodiment of the present disclosure will be described with reference to the drawings. In the drawings, the same or corresponding parts are denoted by the same reference numerals. In the description of the present embodiment, description of the same or corresponding components will be appropriately omitted or simplified.

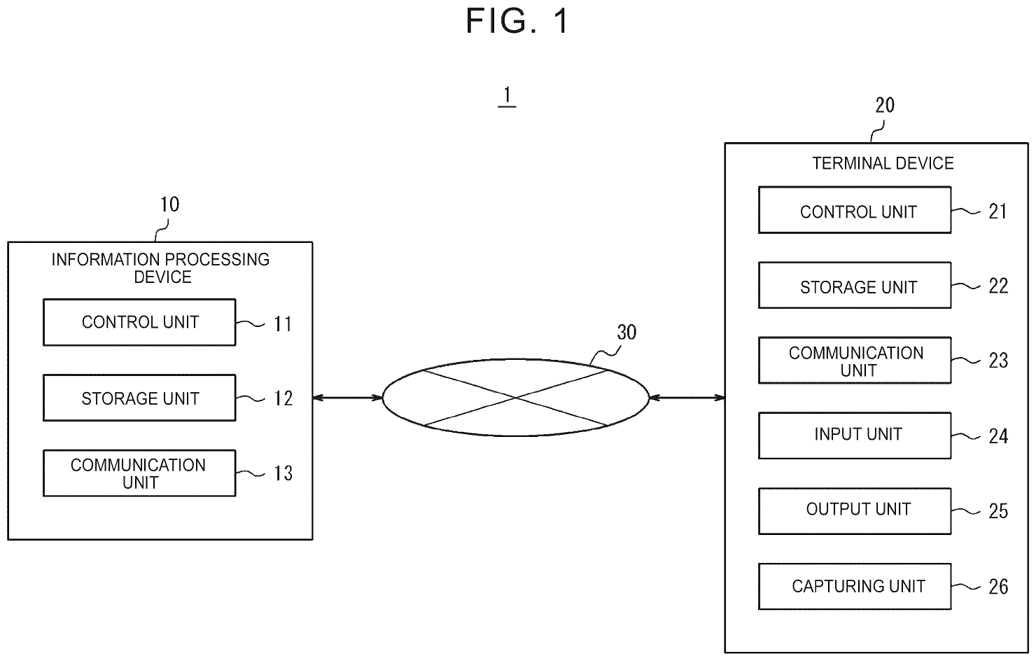

A configuration of the system 1 according to the present embodiment will be described with reference to FIG. 1. The system 1 includes an information processing device 10 and a terminal device 20. The information processing device 10 can communicate with the terminal device 20 via the network 30.

The information processing device 10 is a computer installed in a facility such as a data center. The information processing device 10 is, for example, a server belonging to a cloud computing system or another computing system. The information processing device 10 is operated by a business operator who sells a vehicle.

The terminal device 20 is held by the user. The terminal device 20 is, for example, a mobile device such as a mobile phone, a smart phone, or a tablet, or a PC. The term “PC” is an abbreviation for “personal computer”.

Network 30 includes the Internet, at least one WAN, at least one MAN, or any combination thereof. The term “WAN” is an abbreviation for “wide area network”. The term “MAN” is an abbreviation for “metropolitan area network”. Network 30 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

First, the outline of the present embodiment will be described, and the details will be described later. The terminal device 20 receives an input by the user of the vehicle on which the user is considering the purchase and the environmental condition on which the vehicle is placed, transmits first information indicating the vehicle and the environmental condition, and transmits second information indicating the object placed in the vehicle cabin of the vehicle by the user. The terminal device 20 acquires an image representing an object placed in the vehicle under an environmental condition, which is generated based on the first information and the second information, and outputs the image.

The environmental conditions indicate the environment in which the vehicle's cabin is located, such as the weather, the time zone, the degree of brightness due to the lighting fixtures in the vehicle's cabin, and the like, and can be input by the user as described below. According to the present embodiment, it is possible to easily confirm the vehicle cabin of the vehicle that the user is considering to purchase under the specified environmental conditions together with the object placed in the vehicle cabin. This makes it easier for the user to image the vehicle cabin when the user rides. Therefore, it is possible to improve a technique for providing a simulation of a vehicle cabin.

A configuration of the information processing device 10 according to the present embodiment will be described with reference to FIG. 1. The information processing device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 11 executes processing related to the operation of the information processing device 10 while controlling each unit of the information processing device 10.

The storage unit 12 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The flash memory is, for example, an SSD. The term “SSD” is an abbreviation for solid-state drive. The magnetic memory is, for example, an HDD. The term “HDD” is an abbreviation for hard disk drive. The storage unit 12 may function as, for example, a main storage device, an auxiliary storage device, or a cache memory. The storage unit 12 stores information used for the operation of the information processing device 10 and information obtained by the operation of the information processing device 10.

The communication unit 13 includes at least one communication module. The communication module may be, for example, a wired LAN communication standard such as Ethernet (registered trademark), or a wireless LAN communication standard such as IEEE 802.11. The term “IEEE” is an abbreviation for Institute of Electrical and Electronics Engineers. The communication unit 13 communicates with devices other than the information processing device 10. The communication unit 13 receives information used for the operation of the information processing device 10 and transmits information obtained by the operation of the information processing device 10.

A configuration of the terminal device 20 according to the present embodiment will be described with reference to FIG. 1. The terminal device 20 includes a control unit 21, a storage unit 22, a communication unit 23, an input unit 24, an output unit 25, and a capturing unit 26. The hardware configurations of the control unit 21, the storage unit 22, and the communication unit 23 of the terminal device 20 may be the same as the hardware configurations of the control unit 11, the storage unit 12, and the communication unit 13 of the information processing device 10, respectively. The description here is omitted.

The input unit 24 includes at least one input interface. The input interface is, for example, a physical key, a capacitive key, a pointing device, a touch screen integrated with a display, or a microphone. The input unit 24 receives an operation of inputting data used for the operation of the terminal device 20. Instead of being provided in the terminal device 20, the input unit 24 may be connected to the terminal device 20 as an external input device. As a connection method, for example, any method such as USB, HDMI (registered trademark), or Bluetooth (registered trademark) can be used. The term “USB” is an abbreviation for “universal serial bus”. The term “HDMI (registered trademark)” is an abbreviation for “high-definition multimedia interface”.

The output unit 25 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescence”. The output unit 25 outputs data obtained by the operation of the terminal device 20. The output unit 25 may be connected to the terminal device 20 as an external output device instead of being provided in the terminal device 20. As a connection method, for example, any method such as USB, HDMI (registered trademark), or Bluetooth (registered trademark) can be used.

The capturing unit 26 is a camera that photographs the periphery of the terminal device 20. The capturing unit 26 may be a camera that can photograph a subject three-dimensionally, such as a time of flight (TOF) camera, or a stereo camera. The capturing unit 26 can output the acquired image to the control unit 21. The capturing unit 26 is provided, for example, on a surface opposite to the output unit 25.

The function of the information processing device 10 or the terminal device 20 is realized by executing the program according to the present embodiment by a processor serving as the control unit 11 or the control unit 21. That is, the functions of the information processing device 10 or the terminal device 20 are realized by software. The program causes the computer to execute the operation of the information processing device 10 or the terminal device 20, thereby causing the computer to function as the information processing device 10 or the terminal device 20. That is, the computer functions as the information processing device 10 or the terminal device 20 by executing the operation of the information processing device 10 or the terminal device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

Part or all of the functions of the information processing device 10 or the terminal device 20 may be realized by a programmable circuit or a dedicated circuit as the control unit 11 or the control unit 21. That is, some or all of the functions of the information processing device 10 or the terminal device 20 may be realized by hardware.

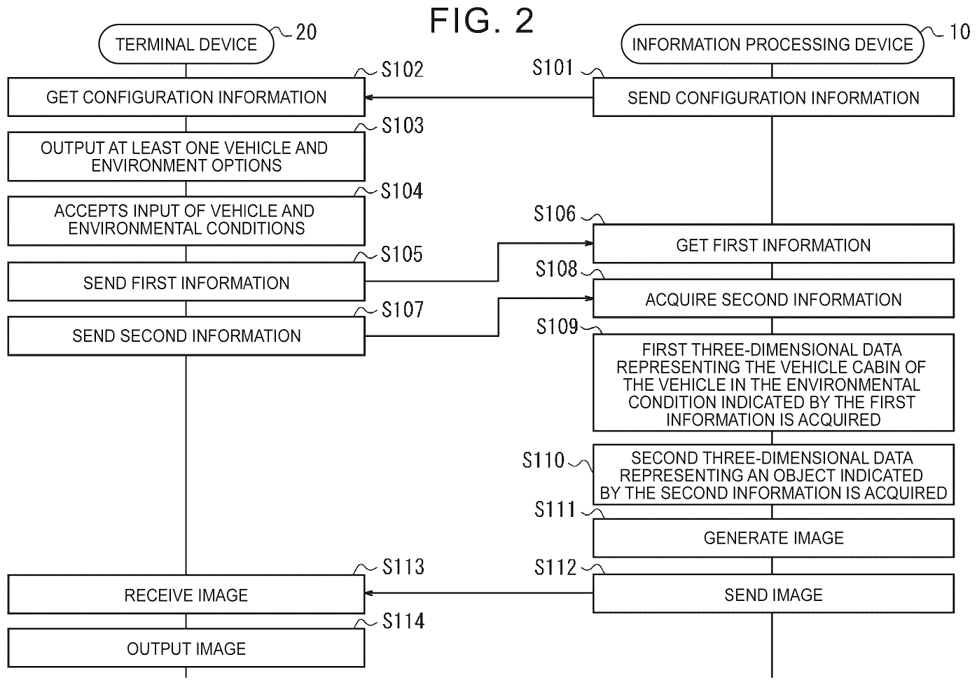

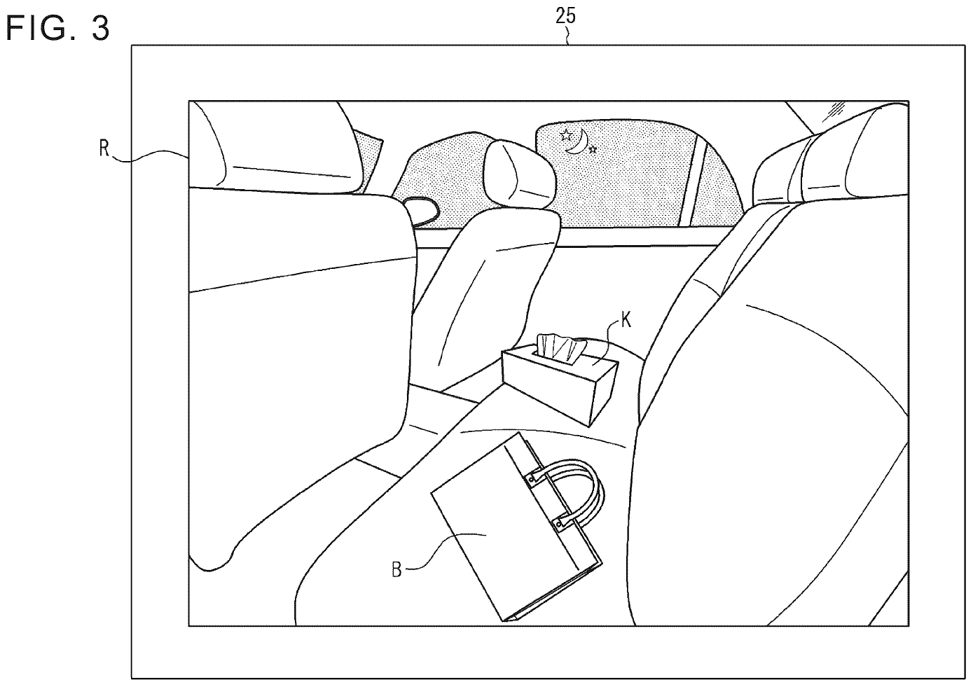

The operation of the system 1 according to the present embodiment will be described with reference to FIGS. 2 and 3. Among the operations illustrated in FIG. 2, the operation of the terminal device 20 corresponds to the method according to the present embodiment. In the following description, communication between the information processing device 10 and the external apparatus is performed via the communication unit 13 and the network 30, and communication between the terminal device 20 and the external apparatus is performed via the communication unit 23 and the network 30.

In S101 of FIG. 2, the control unit 11 of the information processing device 10 transmits setting information indicating at least one sales vehicle and an environmental option in which the vehicle is placed to the terminal device 20. The setting information may be stored in the storage unit 12 of the information processing device 10 in advance. Environmental options include weather, time of day, and the degree of brightness due to lighting fixtures in the vehicle's cabin. In this example, weather environment options include “rain,” “sunny,” “cloudy,” etc. Time zone environment options include “morning,” “day,” “evening,” “night,” etc. Environmental options for the degree of brightness by the lighting fixtures of the vehicle cabin include “high”, “medium”, “low”, and the like. The environmental options may include, but are not limited to, temperature, humidity, and the like. The setting information may include interior options for a plurality of vehicle cabins for the same vehicle. Interior options may include, for example, seats, materials such as dashboards, colors, and the like.

In S102, the control unit 21 of the terminal device 20 acquires the setting information by receiving the setting information.

In S103, the control unit 21 outputs at least one vehicle and an environmental option indicated by the setting information via the output unit 25. Any method may be employed for the output. For example, the control unit 21 may output the at least one vehicle and the environment option by displaying the at least one vehicle and the environment option on the output unit 25 with an icon or the like. In the present embodiment, the control unit 21 outputs the vehicle CA, the vehicle CB, and the vehicle CC and, as environmental options, three types of weather such as “rain”, “sunny”, and “cloudy” via the output unit 15. In addition, the control unit 21 outputs, via the output unit 15, three types of daily time zones of “morning”, “daytime”, and “night”, and the degree of brightness by the lighting fixtures of the vehicle cabins of the three types of vehicles of “low”, “medium”, and “high”. When the setting information includes an interior option of the vehicle cabin, the control unit 21 outputs the interior option.

In S104, the control unit 21 of the terminal device 20 receives, via the input unit 24, an input of a vehicle on which the user is considering purchasing and an environmental condition in which the vehicle is placed. Any method may be adopted for accepting the input. For example, the control unit 11 may receive, as an input, an operation of the user selecting an icon output by S103 via the input unit 24. In the present embodiment, it is assumed that the control unit 21 receives a vehicle CA as a vehicle that the user is considering to purchase. In the present example, it is assumed that the control unit 11 accepts, as the environmental conditions, an input of the degree of brightness by the lighting fixture of the vehicle cabin of the vehicle having the “sunny” weather, the “night” time zone, and the “medium” degree. When the setting information includes an interior option of the vehicle cabin, the control unit 21 may further receive an input from the user of the interior option.

In S105, the control unit 21 generates first information indicating the vehicles and the environmental conditions that have been received by S104, and transmits the first information to the information processing device 10. The first information may include an interior option of a vehicle cabin of the vehicle input by the user.

In S106, the control unit 11 of the information processing device 10 acquires the first information by receiving the first information.

In S107, the control unit 21 of the terminal device 20 generates and transmits the second data indicating the object placed in the vehicle cabin of the vehicle by the user. Any method may be used to generate the second information. For example, the control unit 21 may acquire, from the capturing unit 26, a two-dimensional captured image in which an object is captured by the user using the capturing unit 26, and generate second information including the captured image. In this case, the control unit 21 may acquire a plurality of two-dimensional captured images in which the object is captured from a plurality of directions, and generate second information. The present disclosure is not limited thereto, and the control unit 21 may acquire a three-dimensional captured image from the capturing unit 26 and generate second information including the three-dimensional captured image. In this example, it is assumed that the control unit 11 generates the second information including the three-dimensional captured image of the bag B as the object and the box K of the tissue paper.

In S108, the control unit 11 of the information processing device 10 acquires the second information by receiving the second information.

In S109, the control unit 11 acquires the first three-dimensional data representing the vehicle cabin of the vehicle in the environmental condition indicated by the first information. The three-dimensional data includes, for example, a three-dimensional model, point cloud data, mesh data, and the like. Any method may be employed for acquiring the first three-dimensional data. For example, the control unit 11 acquires three-dimensional data of the vehicle indicated by the first information by referring to the information indicating the vehicle cabin for each vehicle stored in advance in the storage unit 12. The control unit 11 may use an arbitrary image processing technique to apply the environmental condition indicated by the first information to the three-dimensional data and acquire it by generating the first three-dimensional data in which the per isotropy of light is adjusted. When the first information includes an interior option of the vehicle cabin, the control unit 21 acquires first three-dimensional data representing the cabin which the interior option is provided under the environmental condition.

In S110, the control unit 11 acquires second three-dimensional data representing the object indicated by the second information. Any method may be employed for acquiring the second three-dimensional data. For example, the control unit 11 may generate second three-dimensional data representing an object in a three-dimensional shape by using an arbitrary image processing technique on the basis of a plurality of two-dimensional captured images representing an object captured from a plurality of directions. The control unit 11 may acquire the three-dimensional data from the three-dimensional captured image indicated by the second information. The control unit 11 is not limited thereto, and may be acquired by reading out the three-dimensional data of the object from the database of the three-dimensional data stored in advance in the storage unit 12. In this example, it is assumed that the control unit 11 extracts and acquires three-dimensional data from the three-dimensional captured images of the bag B indicated by the second information and the box K of the tissue paper.

In S111, the control unit 11 generates images obtained by combining the first three-dimensional data and the second three-dimensional data. The combined image in the present example is a three-dimensional image representing the vehicle cabin under the environmental condition indicated by the first information, on which the object indicated by the second information is placed. The present disclosure is not limited thereto, and the control unit 11 may generate a two-dimensional image as the synthesized image. Any method may be employed for generating the synthesized image. For example, the control unit 11 may generate an image representing an object placed at a preset position, such as on a seat of a vehicle cabin. The position may be preset by the user. The control unit 11 may apply the environmental condition indicated by the first information to the object by using an arbitrary image processing technique, and generate an image representing the object whose light hit or the like is adjusted.

In S112, the control unit 11 transmits the generated images to the terminal device 20.

In S113, the control unit 21 of the terminal device 20 receives images from the information processing device 10.

In S114, the control unit 21 outputs the received images via the output unit 25. FIG. 3 is a diagram illustrating an example of an image output to the output unit 25 of the terminal device 20. In FIG. 3, the vehicle cabin R of the vehicle CA is displayed under the environmental conditions in which the weather indicated by the first information is “clear”, the time zone is “night”, and the degree of illumination of the vehicle cabin is “medium”. In the vehicle cabin R, a bag B as an object indicated by the second information and a box K of tissue paper are placed. By viewing the three-dimensional image output to the output unit 25, the user can image the vehicle cabin of the vehicle with a sense of presence. Thereafter, the operation of the system 1 ends.

### Second Embodiment

Next, a second embodiment of the present disclosure will be described. Since the configuration of the system 1 according to the second embodiment is the same as that of the first embodiment described above, the description thereof will be omitted. The configurations of the information processing device 10 and the terminal device 20 according to the second embodiment are the same as those of the above-described embodiment, and thus description thereof will be omitted.

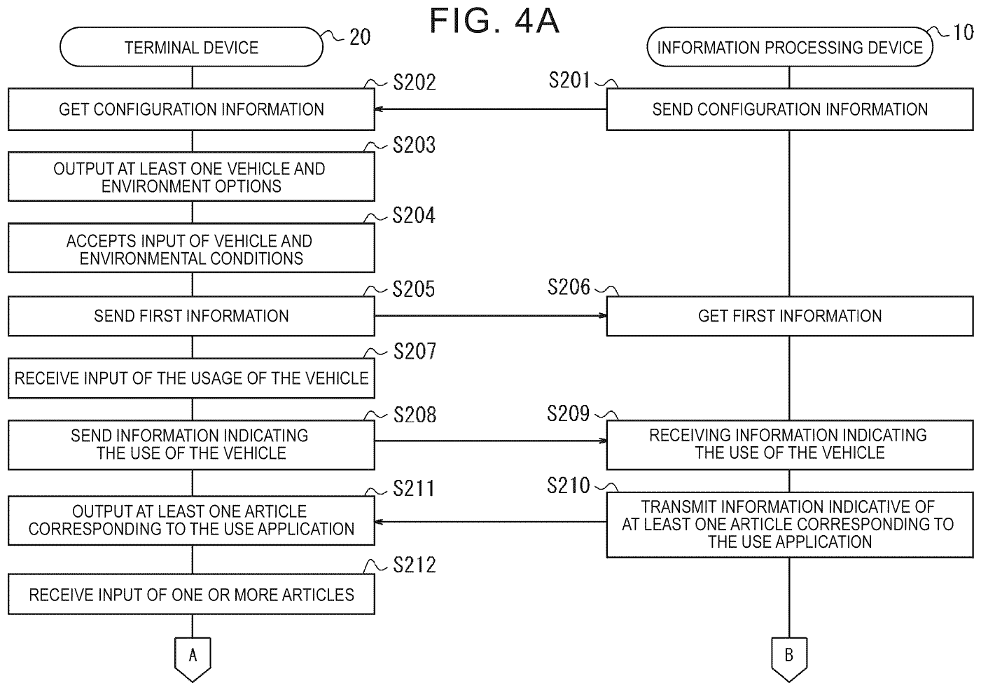

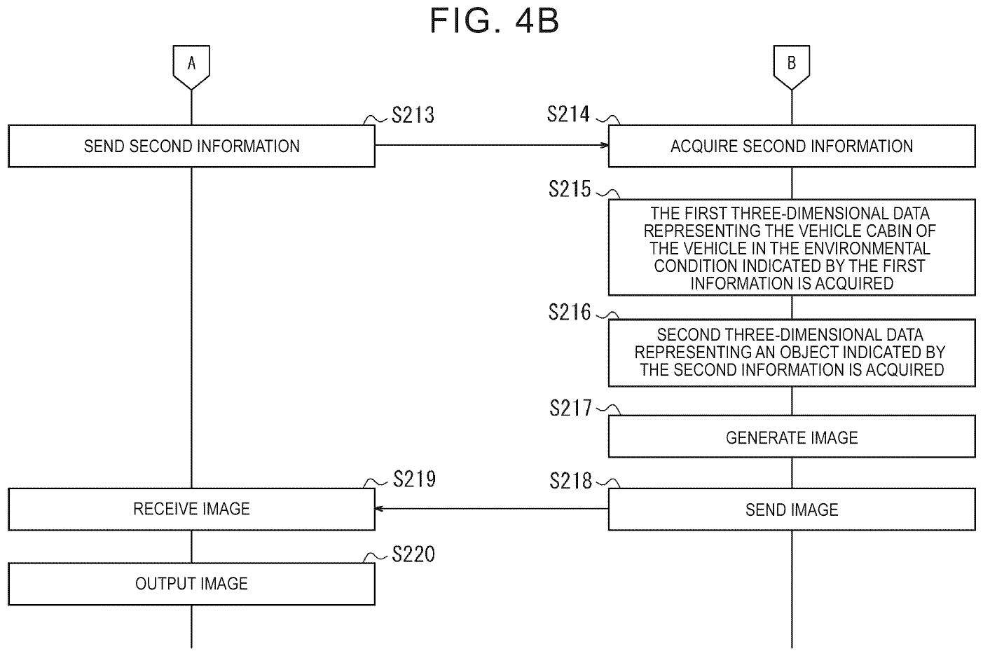

Hereinafter, the operation of the system 1 according to the present embodiment will be described with reference to FIG. 4A and FIG. 4B.

S201 to S206 of FIG. 4A is the same as S101 to S106 of FIG. 2 according to the first embodiment described above, and therefore will not be described.

In S207, the control unit 21 receives an input of a use purpose of the user's vehicle via the input unit 24. Usage may include, for example, “commuting,” “commuting,” “fishing,” “golf,” “daily use,” etc. For example, the control unit 21 may display a plurality of icons indicating the use purpose on the output unit 25, and receive an operation of designating at least one of the icons by the user via the input unit 24. In the present example, it is assumed that the control unit 21 receives an input designating “golf” as a use purpose of the vehicle of the user.

In S208, the control unit 21 generates information indicating the usage and transmits the information to the information processing device 10.

In S209, the control unit 11 of the information processing device 10 receives information indicating a use purpose.

In S210, the control unit 11 generates information indicating at least one item corresponding to the usage indicated by the information received in S209, and transmits the generated information to the terminal device 20. The at least one article corresponding to the use application indicates an article that is highly likely to be placed in a vehicle cabin by being carried by a user or the like when the vehicle is used in the use application. At least one article corresponding to the use application may be stored in the storage unit 12 of the information processing device 10 in advance in association with the use application. For example, when the use application is “daily use”, articles corresponding to the use application may include a “box of tissue paper”, “seat mat”, “shopping bag”, and the like. When the use purpose is “commuting”, the article corresponding to the use purpose may include “business bag”, “PC case”, and the like. When the use application is “fishing”, an article corresponding to the use application may include a “fishing tool”, a “cooler box”, and the like. When the use purpose is “golf”, the article corresponding to the use purpose may include “golf bag”, “round bag”, and the like. In the present example, the control unit 11 generates information indicating “golf bag” and “round bag” as at least one item corresponding to the use purpose, and transmits the information to the terminal device 20.

In S211, the terminal device 20 outputs, via the output unit 25, at least one item corresponding to the usage indicated by the information received in S210. In the present example, the control unit 11 outputs the “golf bag” and the “round bag” via the output unit 25. The article may be displayed by an icon or the like.

In S212, the control unit 21 receives an input of one or more articles selected by the user via the input unit 24. In this example, it is assumed that the control unit 21 receives the input of the “golf bag” selected by the user from the “golf bag” and the “round bag”.

In S213 of FIG. 4B, the control unit 21 generates second information indicating the article inputted in S212 as an object, and transmits the second information to the information processing device 10. In the present example, it is assumed that the control unit 21 generates second information indicating an article “golf bag” as an object and transmits the second information to the information processing device 10.

In S214, the control unit 11 of the information processing device 10 acquires the second information by receiving the second information.

S215 is the same as S109 of FIG. 2 according to the first embodiment described above, and therefore will not be described.

In S216, the control unit 11 acquires second three-dimensional data representing the object indicated by the second information. Any method may be employed for acquiring the second three-dimensional data. For example, the control unit 11, from the database of three-dimensional data stored in advance in the storage unit 12 may be acquired by reading the three-dimensional data of the object. In this example, it is assumed that the control unit 11 acquires three-dimensional data of the golf bag indicated by the second information.

S217 to S220 is the same as S111 to S114 of FIG. 2 according to the first embodiment described above, and therefore will not be described.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, in S114 of the above-described first embodiment or in S220 of the second embodiment, the control unit 21 of the terminal device 20 may arrange a plurality of images and simultaneously output them to the output unit 25. The plurality of images may be images generated by the information processing device 10 in S111 of FIG. 2 or S217 of FIG. 4B described above, with any of the vehicle cabin, the environmental condition, or the object or the article corresponding to the use application being different from each other. As a result, the user can compare the images of the vehicle cabin of the vehicle under different conditions.

What is claimed is:

1. A method executed by a terminal device including an input unit, an output unit, a communication unit, and a control unit, wherein the control unit performs a process including
receiving, via the input unit, an input by a user of a vehicle that the user is considering to purchase and an environment condition for an environment in which the vehicle is to be placed,
transmitting, via the communication unit, first information indicating the vehicle and the environment condition,
transmitting, via the communication unit, second information indicating an object to be placed in a vehicle cabin of the vehicle by the user,
acquiring, via the communication unit, an image generated based on the first information and the second information and representing the object placed in the vehicle in the environment condition, and
outputting the image via the output unit.

2. The method according to claim 1, wherein the image is a three-dimensional image in which first three-dimensional data representing the vehicle cabin of the vehicle in the environment condition and second three-dimensional data representing the object are combined.

3. The method according to claim 1, wherein the environment condition further includes a degree of brightness caused by a lighting fixture in the vehicle cabin of the vehicle.

4. The method according to claim 1, wherein the control unit further performs a process including
receiving, via the input unit, an input by the user of a purpose of use of the vehicle,
outputting, via the output unit, at least one article corresponding to the purpose of use,
receiving, via the input unit, an input of one or more articles selected by the user, and
transmitting, via the communication unit, the second information indicating the articles selected by the user as the object.

5. The method according to claim 1, wherein:
the terminal device further includes a capturing unit;
the control unit further performs a process including acquiring an image capturing the object and captured by the user using the capturing unit; and
the second information includes the captured image.
